(19) United States
(12) Patent Application Publication
(10) Pub. No.: US 2016/0379153 A1
(43) Pub. Date: Dec. 29, 2016

(54) COLLECTIVE DYNAMICS

(71) Applicant: Avaya Inc., Santa Clara, CA (US)

(72) Inventors: Valentine C. Matula, Granville, OH (US); David Skiba, Golden, CO (US); George Erhart, Loveland, CO (US)

(21) Appl. No.: 14/748,400

(22) Filed: Jun. 24, 2015

(51) Int. Cl. G06Q 10/06

(52) U.S. Cl. CPC G06Q 10/063114; G06Q 10/063116

(57) ABSTRACT

Many factors can affect the operation of a contact center, especially contact centers utilizing human agents. An agent's health may be utilized as a predictor of performance with respect to a particular task. Having sensors to gather health data are provided. The data may then be aggregated into a long-term health trend, which may be determined to indicate that a change in an agent's performance is likely and may allow the contact center to reallocate tasks and/or other resources to accommodate the change in performance to mitigate the effect of the change in the agent's health. Work tasks are then routed to agents accordingly.

### FIELD OF THE DISCLOSURE

The present disclosure is generally directed toward self-learning computational system resources.

### BACKGROUND

Contact centers spend a tremendous amount of effort, money, and other resources for staffing. Overstaffing results in higher costs and understaffing may result in poor contact center performance and lower customer satisfaction. Efficient scheduling of resources requires accurate forecasting of work, productivity, and other staffing requirements. Existing systems often consider a predicted workload (e.g., Christmas or other holiday activity peaks) and attempt to have staff in place to accommodate such cyclical activity peaks. Staff may be reduced in terms of personnel or hours worked to avoid overstaffing during times when activity cycles to a valley. For example, holiday staff may be hired with the expectation of working during the holiday peak and, based on a previously determined date, have their term of employment end when the peak passes.

Knowing historic activity provides one indicator for future staffing levels. However, despite having such knowledge, problems remain and contact centers often find themselves overstaffed, understaffed, or having staff unable to meet expectations.

### SUMMARY

It is with respect to the above issues and other problems that the embodiments presented herein were contemplated. Prior workforce management (WFM) systems fail to consider the health trends related to personnel including, but not limited to, contact center resources, high-level trends, and specific events, and fail to be flexible enough to make adjustments accordingly.

In one embodiment of the present disclosure, long-term monitoring and the resulting employees' performances are provided by a collective dynamics module to predict daily, weekly, and seasonal conditions of job performance. The collective dynamics module may then provide the predictive data to the WFM system for use in staffing and work assignment analysis, predictions, forecasts, and adjustments.

As a benefit of certain embodiments, long term monitoring and resulting employee performance is provided to predict interval and seasonal conditions of job performance. The collective dynamics module is operable to provide larger scale health monitoring models to be used by WFM systems.

Additional modeling, such as staff performance and turnover can include individual averages, bases, and optimal performance with ranges (e.g., learning to push to limits) that can be applied to others. Agent performance can be tied to long-term performance and trends. Routing of work items may be based on agent health and skills (e.g., jumpy, quick, gets calls to move through quickly vs. slower, methodical, sleepy). Using a collective dynamics module, the health and performance data can be reported for groups, teams, locations, company, etc.

Work item routing may be based on agent skill, health, history, and alertness to assess an agent's ability to perform a task and at what level of proficiency. Embodiments herein may provide a system to map “coming to work activities” to fitness. The workforce model can characterize what days, in relation to employee skill proficiency, or types of employees that are best suited for a particular task or task category: for example, Monday subprime, Tuesday-Thursday prime, and Friday average. Staffing may be based on a fundamental set of daily requirements and through mapping of successful characteristics and indicators for long-term retention. Additionally, such performance attributes may be utilized to screen potential new hires and/or to evaluate performance during a probationary period. Using health attributes of the full workforce, a contact center may be better able to perform long-term planning and hiring.

As a benefit of the embodiments provided in the current disclosure, work assignments may be made based on work type. For example, if a company wants to achieve a certain objective, it may wish to engage agents in prime condition. If agents are determined to be in prime condition on Tuesday, the work assignment may change the Tuesday focus to customer experience and change the Friday focus to outbound campaigns when agent productivity is only average. Additional models, such as those taking into consideration seasonal and yearly performance, are also contemplated by the embodiments disclosed herein.

In an additional embodiment, health monitoring can be tied to external events, such as weather, concerts, football, emergencies, etc. Results of health monitoring, which may include biometrics, can be analyzed for performance differences. The collective dynamics module can tie work assignment and routing to recurring common external events using the biometrics, history, and other predictors to shape performance.

For example, a large sporting event (e.g., World Series, Superbowl, Stanley Cup, etc.) may cause agents and potential customers in the geographic regions associated with both competing teams to be tired or otherwise suboptimal performers the day after the event. As a benefit of certain embodiments disclosed herein, agent staffing and work assignment can be shifted based on predictors of work performance accordingly. The impact may be more profound depending on time zones. For example, fans on the East Coast watching a televised event occurring on the West Coast have the additional burden of being three hours later, which may further degrade staff performance the following day.

In one embodiment, a system is disclosed comprising: a network interface configured to receive a long-term health trend of an agent in a work pool; a processor to determine an impact of the long-term health trend on a performance objective of the contact center and select a mitigation strategy to mitigate the long-term health trend on the performance objective; an assignment module configured to assign a work task to a portion of the work pool in accord with the mitigation strategy; and, a switch configured to route the assigned work task to at least one agent of the portion of the work pool.

In another embodiment, a system is disclosed comprising: a sensor configured to receive a health-indicating attribute of the agent and convert the received health-indicating attribute into a long-term health trend datum; a data store configured to receive the long-term health trend datum for access by the network interface as a component of the long-term health trend; a network interface configured to receive a long-term health trend of an agent in a work pool; a processor to determine an impact of the long-term health trend on a performance objective of the contact center and select a mitigation strategy to mitigate the long-term health trend on the performance objective; an assignment module configured to assign a portion of the work pool to perform a work task in accord with the mitigation strategy; and, a switch configured to route the assigned work task to at least one agent of the portion of the work pool.

In another embodiment, a method is disclosed comprising: a network interface configured to receive a long-term health trend of an agent in a work pool; a processor to determine an impact of the long-term health trend on a performance objective of the contact center and select a mitigation strategy to mitigate the long-term health trend on the performance objective; an assignment module configured to assign a work task to a portion of the work pool in accord with the mitigation strategy; and, a switch configured to route the assigned work task to at least one agent of the portion of the work pool.

The type of work performed by the agent and the work pool may vary. In one embodiment, the agent is customer service or similar agent within a work pool of a contact center, performing acts such as tending to inbound and/or outbound telephone, video-phone, email, and or other communications associated with a customer, potential customer, or other contact. In another embodiment, the agent is a driver in a work pool of an enterprise that picks up or delivers persons or objects. As can be appreciated, other types of work performed are also contemplated without departing from the scope of this disclosure.

The term “long-term,” such as used herein with, “long-term health trend” refers to a period of observation. While a long-term health issue, such as a disease or condition that may progress over days or years may be observed, it is the time period of observation that is referenced herein. A long-term health trend may require a number of observations, such as to indicate a pattern, or a single observation. For example, certain contact center performance metrics may indicate a pattern whereby certain types of campaigns (e.g., upselling versus new sales) are more successful, take less time, have higher customer satisfaction, and/or other agent-determined metrics on certain days of the week, following staff meetings, following a different work assignment, etc. A single observation may include a performance metric following a previous event, a single measurement deviating from an established norm, or an indicator that an agent is within a particular population sample (e.g., one temperature reading indicating the agent within the population sample having influenza). As will be described more completely with respect to the embodiments that follow, the trend may or may not be established from attributes of the same agent for which any future predictions are based.

The duration of a long-term health trend is variously embodied and may be selected as a matter of design or implementation choice. A long-term health trend is predictive and not an absolute condition. For example, an agent diagnosed as having influenza and, absent a mitigating effort, causing the contact center to be short an agent, would be different from a long-term health trend and the effect is not predictive but known. However, the length of an agent's illness may be predictive and, therefore, a long-term health trend. In one embodiment, long-term comprises a period of time that cannot be observed prior to an agent reporting for work. In another embodiment, a long-term health trend is at least two work shifts. In another embodiment, a long-term health trend comprises observations of at least two persons that may or may not be agents. In another embodiment, a long-term health trend comprises weekly, monthly, seasonally, yearly, or other repeating events. As described more completely with respect to the embodiments below, a long-term health trend may be an observation over time or an exception to the observations over time.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts an agent-work item matching system in accordance with embodiments of the present disclosure;

FIG. 4 depicts a data structure in accordance with embodiments of the present disclosure;

FIG. 5 depicts a communication system in accordance with embodiments of the present disclosure; and

FIG. 6 depicts a process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

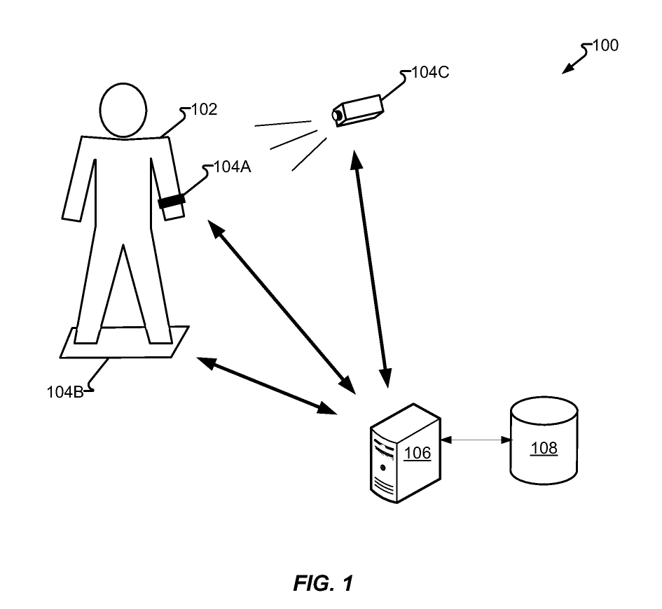

FIG. 1 depicts system 100 in accordance with embodiments of the present disclosure. In one embodiment, a single agent 102 is monitored by one or more sensing devices 104A-C to gather data and determine a long-term health trend. Sensing devices 104 may comprise any device or devices configured to receive a measurement of an attribute of agent 102, which may be utilized in determining a long-term health trend. Sensing devices 104 are variously embodied and may include one or more of wearable sensor 104A, pressure mat 104B, and remote sensor 104C. Remote sensor 104C may comprise visual imagery, infrared, ultraviolet, or other portion of the electromagnetic spectrum. In another embodiment, sensing device 104 may comprise devices to determine a health concern self-determined by agent 102. For example, agent 102 may utilize a computer database or search engine to investigate health concerns, such as “treating influenza,” “fatigue,” etc. A change in the frequency of such actions and/or a deviation from what would be considered normal for one having the demographics of agent 102, may indicate a change in a long-term health trend.

Sensing devices 104 measure an attribute of agent 102. The attribute may be physiological and/or behavioral. For example, wearable sensing device 104A may be configured to measure heart rate, respiration, body temperature, activity level, blood chemistry, etc. In another example, pressure mat 104B may measure weight, activity, and presence or absence in a particular area (e.g., standing at a desk, sitting in a chair, etc.). Remote sensor 104C may receive a behavioral attribute, such as motion or activity, time in a particular area, body position, and/or other motion-based attributes. Additionally, remote sensor 104C may determine physiological attributes, such as body temperature, respiratory efficiency (e.g., comparing atmospheric gas levels to exhalation gas levels), body/blood chemistry (e.g., spectral analysis on exhalation, oxygen saturation), etc.

Sensing devices 104 collect one or more attribute measurements in a computer-readable form (e.g., voltage, resistance, acceleration, etc.) associated with a datum measuring the health of agent 102. Sensing devices 104 connect to server 106 directly or via an intermediate device (e.g., router, wired network, wireless network, Internet connection, etc.). Server 106 may optionally utilize storage 108 comprising internal, external, and/or remote (e.g., Internet, “cloud,” offsite, etc.) storage. Server 106 may determine a long-term health trend. Server 106 may then provide signals to other components in anticipation of agent 102 being in an affected state. In one embodiment, an affected state is an impaired state, such as when an agent 102 is unable to perform at an expected proficiency level for a particular task or category of tasks. For example, agent 102 normally has eight hours of sleep; however, as reported by wearable sensing device 104A, agent 102 received nine hours of sleep two nights ago and ten hours of sleep one night ago. Accordingly, a health trend (e.g., increasing sleep) may be determined, which may be associated with fatigue or the onset of an illness. As a result, agent 102 may be assigned to less intellectually demanding work tasks. In another embodiment, an affected state may be a prime state wherein agent 102 is more likely or able to perform above an expected proficiency level for a particular task. For example, agent 102 may be more likely to perform exceptionally well following certain physical or mental activities.

In one embodiment, server 106 analyzes data received from sensing devices 104 to establish a long-term health trend, or portion thereof. For example, pressure mat 104B may indicate agent 102 is standing more often as compared to sitting. The change may be gradual, such as over months or years, or over a shorter time, such as a few days. Server 106 may then determine that agent 102 is establishing a pattern of increased physical activity (e.g., standing versus sitting). Server 106 may compare the performance of agent 102 and determine that an agent is more alert or otherwise more productive, such as may indicate an opportunity to give more difficult assignments to agent 102. Alternatively, server 106 may determine that agent 102 when standing more on pressure mat 104B may have other issues (e.g., lower back pain, etc.) and be impaired following a period of time spent standing on pressure mat 104B.

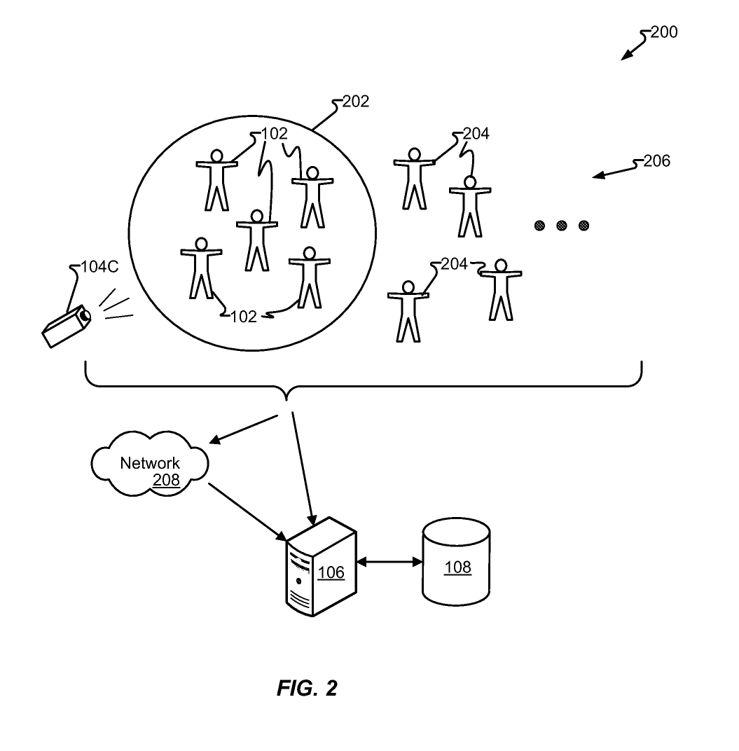

FIG. 2 depicts system 200 in accordance with embodiments of the present disclosure. In one embodiment, system 200 illustrates population sample 206 comprising agents 102 within a work pool, such as agent pool 202 as well as one or more non-agents 204. Non-agents 204 may be different agents (e.g., agents at a different location, agents working a different shift, agents assigned to a different task, etc.) or non-agents 204 (e.g., persons living in the same geographic area, persons of the same demographic category as at least a portion of the members of agent pool 202, general public, etc.).

Sensing device 104 monitors population sample 206 or a subset of the population sample 206, such as the plurality of agents 102 with an agent pool 202 and/or the plurality of non-agents 204. Sensing device 104 may comprise image sensor 104C or other sensing devices 104. As a benefit, a plurality of observations may be made for population sample 206, which may comprise a particular agent 102. For example, imaging device 104C may be placed at a location to observe random persons (e.g., persons having no greater likelihood of being an agent 102 than any other grouping of persons), such as a mall, sporting event, school or other general location. Sensing device 104C may determine via infrared imaging that a growing number of agents 102 in agent pool 202 and non-agents 204 within population sample 206 have an elevated body temperature. As members of agent pool 202 are within population sample 206, it then may be concluded that a long-term health trend indicating the onset or outbreak of an illness is occurring, which would affect agent pool 202.

In another embodiment, population sample 206 may utilize a public network 208 to perform activities indicating an affected event has occurred within population sample 206. For example, if population sample 206 is within a particular geographic area and searches for terms, such as “influenza,” have increased, server 106 may conclude that a long-term health trend of influenza has affected population sample 206 and, in particular, agent pool 202, which may then affect the operation of a contact center.

In another embodiment, non-agents 204 may be in a different geographical location. Non-agents 204 may have experienced an event which is determined to be likely indicative of the performance of agent pool 202. For example non-agents 204 may live in a city who recently had a large sporting event the previous year. Agent pool 202 may live in a different city which is now experiencing or about to experience the same sporting event. As a result, the long-term health trend observed from non-agents 204 may then indicate that agents 102 of agent pool 202 will likely experience the same long-term health trend. Other events may include particular weather events, health events (e.g., disease outbreaks), political events, crime events, and/or other factors, which indicate an ability to affect the performance of agents 102 and/or agent pool 202.

In another embodiment, server 106 may observe a particular activity, such as by accessing network 208 to determine a spike in social network activity. Although the spike in social network activity may have a known subject matter, the activity level alone may be sufficient to indicate population sample 206 has become more interested in the social network. Server 106 may then determine that agent pool 202 may be less focused on their work and more distracted by the social network associated with network 208.

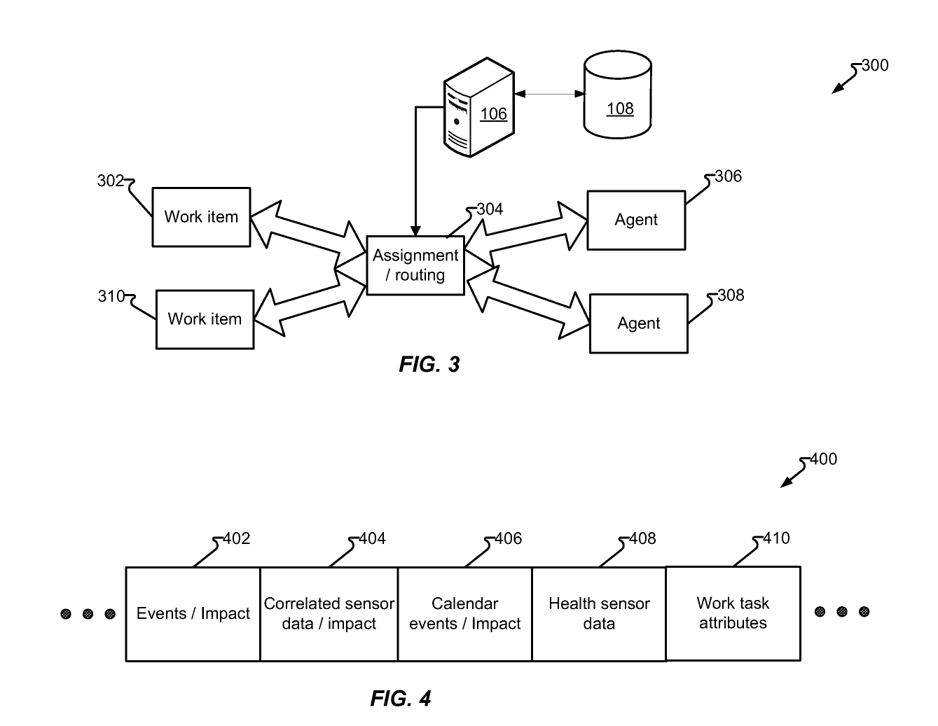

FIG. 3 depicts agent-work item matching system 300 in accordance with embodiments of the present disclosure. In one embodiment, system 300 matches work item 302, 310 to agent 306, 308. Agent 306, 308 may comprise agents 102 who are configured to accept work item 302, 310 and not, for example, off work or otherwise unable to accept work items 302, 310. Agents 306, 308 may be a single agent or a plurality, such as work pool 202 or agents 102 assigned to a particular work task or activity. Each of work item 302, 310 may be a single work item (e.g., call a particular customer about a reservation, answer the next call, etc.) or a category or type of work item (e.g., inbound calls, outbound calls to the East Coast, platinum-level frequent fliers, etc.).

In one embodiment, assignment/routing engine 304 matches work item(s) 302, 310 to a particular agent(s) 306, 308. In another embodiment, assignment/routing engine 304 matches agent 306 or a number of agents 102 to a particular work item 302. As a benefit, assignment/routing engine 304 may assign work to a particular worker and/or workers to a particular work item in accord with a long-term health trend of agent 306, 308. Additionally, assignment/routing engine 304 may alter the scheduling of the number of agents 102 assigned to become agents 306,308 so that staffing levels are appropriate for a particular long-term health trend. For example, if population sample 206 indicates a widespread influenza outbreak next week, assignment/routing engine 304 may cause a scheduling module to increase the pool of agents 102 assigned to work or indicate a need to accelerate hiring of agents 102 in anticipation of agents 102 being impaired or unable to work.

Assignment/routing engine 304 may modify the matching of work item 302 to agent 306 based upon a long-term health trend. For example if a particular agent 306 is believed to be in an impaired state and work item 302 is an inbound call from a platinum level customer, assignment/routing engine 304 may not assign work item 302 to agent 306 in an effort to provide the platinum level customer with an optimum experience associated with an unimpaired agent.

In one embodiment, work item 302 is to be routed to one of agent 306 or agent 308. Assignment/routing engine 304 may assign work item 302 based upon one of agents 306, 308 being impaired or otherwise in a less than optimal state based upon a long-term health trend or, alternatively, assigned to the other of agents 306, 308 being in a prime or otherwise above normal state based upon the long-term health trend. In another embodiment, agent 306 is to be assigned work item 302 or work item 310 based, at least in part, on assignment/routing engine 304 determining that a long-term health trend associated with agent 306 provides for at least one advantage or minimizes at least one disadvantage of assigning agent 306 work item 302 or work item 310.

FIG. 4 depicts data structure 400 in accordance with embodiments of the present disclosure. In one embodiment, data structure 400 comprises data stored in a memory or storage medium in a computer-readable form. Data structure 400 comprises events/impact records 402, whereby a long-term health trend may be determined by one or more prior events and an associated impact of such events. As a benefit, long-term health trend may be determined and an appropriate mitigation action selected. For example, event/impact records 402 may comprise one entry whereby a prior event is a minor holiday and the associated impact is negligible or otherwise within expected variation of the performance, such as by population sample 206, agent 102, or agent pool 202.

Correlated sensor data/impact 404 may comprise one or more records, whereby raw sensor data, such as by sensing device 104, is correlated to an input and is a portion of a long-term health trend. For example wearable sensor device 104A may report an elevated heart rate due to an unknown cause (e.g., exercise, illness, etc.). Such an event may or may not be associated with the long-term health trend. For example, agent 102 may be watching an exhilarating movie, exercising, or otherwise engaging in a routine behavior associated with an increased heart rate. However, agent 102, over the course of months or even years, may have a steady increase in heart rate indicating a long-term health trend, which may further indicate a need to assign agent 102 to less physically demanding activities.

Calendar event/impact 406 may comprise one or more records whereby historical calendar events and their impacts may be associated with a particular long-term health trend. For example, holidays, sporting events, weather events, and/or other events, which repeat in a predictable manner, such as on the same day or in the same season. For example, agent 102 may perform at a higher than normal level on the days following payday; as a result, a long-term health trend may be determined, such as to indicate an ability for assignment/routing engine 304 to assign agent 102 to more demanding tasks on the days following payday.

Health sensor data 408 may comprise one or more records from one or more sensing devices 104. Health sensor data 408 may provide a historic repository of health sensor data from sensing data 104 for access by other components. As a benefit, health sensor data 408 may be utilized, such as by server 106 to determine a long-term health trend and/or any consequences which follow. For example health sensor data 408 may indicate agent 102 has periodic bouts of insomnia. With the benefit of correlated sensor data/impact 404, server 106 may determine a long-term health trend; for example, such bouts of insomnia only occur at predictable intervals or the performance of agent 102 is impaired only upon certain bouts of insomnia and not others.

Work task attributes 410 comprise one or more records associating the demands required to perform certain work tasks, such as work items 302, 310. As a benefit, assignment/routing engine 304 may provide particular work item/agent matches. For example, work item 302 may have a work task attribute record 410 indicating a high demand for problem-solving (e.g., tech support, etc.). Assignment/routing engine 304 may provide work item 302 having the higher problem-solving requirement to one of agents 306, 308 determined to be better suited for such a task.

Data structure 400 may comprise one or more of records 402-410 as well as additional records, as a matter of design choice. For example, data structure 410 may comprise attributes of agent 102, agents 306, 308, agent pool 202, agents 204, and/or population sample 206. As a benefit, server 106 may derive a long-term health trend associated with agent 102 or other agent.

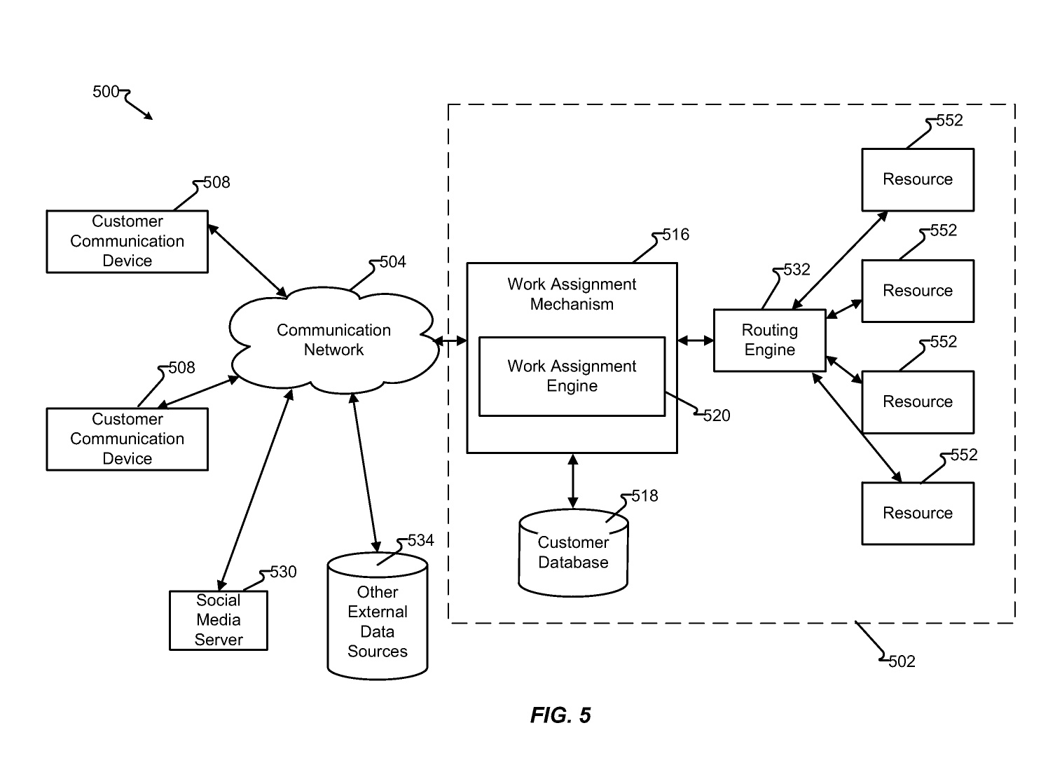

With reference now to FIG. 5, communication system 500 is discussed in accordance with at least some embodiments of the present disclosure. The communication system 500 may be a distributed system and, in some embodiments, comprises a communication network 504 connecting one or more communication devices 508 to a work assignment mechanism 516, which may be owned and operated by an enterprise administering contact center 502 in which a plurality of resources 552 are distributed to handle incoming work items (in the form of contacts) from customer communication devices 508.

In another embodiment, routing engine 532 may comprise, be comprised by, integrated with, in communication with, or provide assignment/routing engine 304. In yet another embodiment, work assignment engine 520 and/or work assignment mechanism 516 may similarly provide or communicate with assignment/routing engine 304. Agent 102 may comprise resource 552 when resource 552 is embodied as a human agent configured to receive work items from routing engine 532. Work items, such as work items 302, 310, may be received by customer communication device 508 utilizing communication network 504. Social media server 530 may be accessed via communication network 504, such as the Internet or other network including network 208, whereby social network data may be received from social media server 530.

Contact center 502 is variously embodied to receive and/or send messages, which may include or comprise work items that are or are associated with work items (e.g., work items 302, 310) and the processing and management (e.g., scheduling, assigning, routing, generating, accounting, receiving, monitoring, reviewing, etc.) of the work items by one or more resources 552. The work items are generally generated and/or received requests for a processing resource 552 embodied as, or a component of, an electronic and/or electromagnetically conveyed message. Contact center 502 may include more or fewer components than illustrated and/or provide more or fewer services than illustrated. The border indicating contact center 502 may be a physical boundary (e.g., a building, campus, etc.), legal boundary (e.g., company, enterprise, etc.), and/or logical boundary (e.g., resources 552 utilized to provide services to customers for a customer of contact center 502).

Furthermore, the border illustrating contact center 502 may be as-illustrated or, in other embodiments, include alterations and/or more and/or fewer components than illustrated. For example, in other embodiments, one or more of resources 552, customer database 518, and/or other component may connect to routing engine 532 via communication network 504, such as when such components connect via a public network (e.g., Internet). In another embodiment, communication network 504 may be a private utilization of, at least in part, a public network (e.g., VPN); a private network located, at least partially, within contact center 502; or, a mixture of private and public networks that may be utilized to provide electronic communication of components described herein. Additionally, it should be appreciated that components illustrated as external, such as social media server 530 and/or other external data sources 534, may be within contact center 502 physically and/or logically, but still be considered external for other purposes. For example, contact center 502 may operate social media server 530 (e.g., a website operable to receive user messages from customers and/or resources 552) as one means to interact with customers via their customer communication device 508.

Customer communication devices 508 are embodied as external to contact center 502 as they are under the more direct control of their respective user or customer. However, embodiments may be provided whereby one or more customer communication devices 508 are physically and/or logically located within contact center 502, such as when a customer utilizes customer communication device 508 at a kiosk, attaches to a private network of contact center 502 (e.g., WiFi connection to a kiosk, etc.), within or controlled by contact center 502, and is still considered external to contact center 502.

It should be appreciated that the description of contact center 502 provides at least one embodiment whereby the following embodiments may be more readily understood without limiting such embodiments. Contact center 502 may further be altered, added to, and/or subtracted from without departing from the scope of any embodiment described herein and without limiting the scope of the embodiments or claims, except as expressly provided.

Additionally, contact center 502 may incorporate and/or utilize social media website 530 and/or other external data sources 534 may be utilized to provide one means for a resource 552 to receive and/or retrieve contacts and connect to a customer of a contact center 502. Other external data sources 534 may include data sources, such as service bureaus, third-party data providers (e.g., credit agencies, public and/or private records, etc.). Customers may utilize their respective customer communication device 508 to send/receive communications utilizing social media website 530.

In accordance with at least some embodiments of the present disclosure, the communication network 504 may comprise any type of known communication medium or collection of communication media and may use any type of protocols to transport electronic messages between endpoints. The communication network 504 may include wired and/or wireless communication technologies. The Internet is an example of the communication network 504 that constitutes an Internet Protocol (IP) network consisting of many computers, computing networks, and other communication devices located all over the world, which are connected through many telephone systems and other means. Other examples of the communication network 504 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 504 need not be limited to any one network type, and instead may be comprised of a number of different networks and/or network types. As one example, embodiments of the present disclosure may be utilized to increase the efficiency of a grid-based contact center 502. Examples of a grid-based contact center 502 are more fully described in U.S. Patent Publication No. 2010/0296417 to Steiner, the entire contents of which are hereby incorporated herein by reference. Moreover, the communication network 504 may comprise a number of different communication media, such as coaxial cable, copper cable/wire, fiber-optic cable, antennas for transmitting/receiving wireless messages, and combinations thereof.

The communication devices 508 may correspond to customer communication devices. In accordance with at least some embodiments of the present disclosure, a customer may utilize their communication device 508 to initiate a work item (e.g., work items 302,310). Illustrative work items include, but are not limited to, a contact directed toward and received at a contact center 502, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 504. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 516, but rather may be on some other server in the communication network 504 where it is harvested by the work assignment mechanism 516, which generates a work item for the harvested communication, such as social media server 530. An example of such a harvested communication includes a social media communication that is harvested by the work assignment mechanism 516 from a social media network or server 530. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively, each of which is hereby incorporated herein by reference in its entirety.

The format of the work item may depend upon the capabilities of the communication device 508 and the format of the communication. In particular, work items are logical representations within a contact center 502 of work to be performed in connection with servicing a communication received at contact center 502 and, more specifically, the work assignment mechanism 516. The communication may be received and maintained at the work assignment mechanism 516, a switch or server connected to the work assignment mechanism 516, or the like, until a resource 552 is assigned to the work item representing that communication at which point the work assignment mechanism 516 passes the work item to a routing engine 532 to connect the communication device 508, which initiated the communication, with the assigned resource 552.

Although the routing engine 532 is depicted as being separate from the work assignment mechanism 516, the routing engine 532 may be incorporated into the work assignment mechanism 516 or its functionality may be executed by the work assignment engine 520.

In accordance with at least some embodiments of the present disclosure, the communication devices 508 may comprise any type of known communication equipment or collection of communication equipment. Examples of a suitable communication device 508 include, but are not limited to, a personal computer, laptop, Personal Digital Assistant (PDA), cellular phone, smart phone, telephone, or combinations thereof. In general, each communication device 508 may be adapted to support video, audio, text, and/or data communications with other communication devices 508 as well as the processing resources 552. The type of medium used by the communication device 508 to communicate with other communication devices 508 or processing resources 552 may depend upon the communication applications available on the communication device 508.

In accordance with at least some embodiments of the present disclosure, the work item is sent toward a collection of processing resources 552 via the combined efforts of the work assignment mechanism 516 and routing engine 532. The resources 552 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact center 502.

As discussed above, the work assignment mechanism 516 and resources 552 may be owned and operated by a common entity in a contact center 502 format. In some embodiments, the work assignment mechanism 516 may be administered by multiple enterprises, each of which has its own dedicated resources 552 connected to the work assignment mechanism 516.

In some embodiments, the work assignment mechanism 516 comprises a work assignment engine 520, which enables the work assignment mechanism 516 to make intelligent routing decisions for work items. In some embodiments, the work assignment engine 520 is configured to administer and make work assignment decisions in a queueless contact center 502, as is described in U.S. patent application Ser. No. 12/882,950, the entire contents of which are hereby incorporated herein by reference. In other embodiments, the work assignment engine 520 may be configured to execute work assignment decisions in a traditional queue-based (or skill-based) contact center 502.

The work assignment engine 520 and its various components may reside in the work assignment mechanism 516 or in a number of different servers or processing devices. In some embodiments, cloud-based computing architectures can be employed whereby one or more components of the work assignment mechanism 516 are made available in a cloud or network such that they can be shared resources among a plurality of different users. Work assignment mechanism 516 may access customer database 518, such as to retrieve records, profiles, purchase history, previous work items, and/or other aspects of a customer known to contact center 502. Customer database 518 may be updated in response to a work item and/or input from resource 552 processing the work item.

In one embodiment, a message is generated by customer communication device 508 and received, via communication network 504, at work assignment mechanism 516. The message received by a contact center 502, such as at the work assignment mechanism 516, is generally, and herein, referred to as a “contact.” Routing engine 532 routes the contact to at least one of resources 552 for processing.

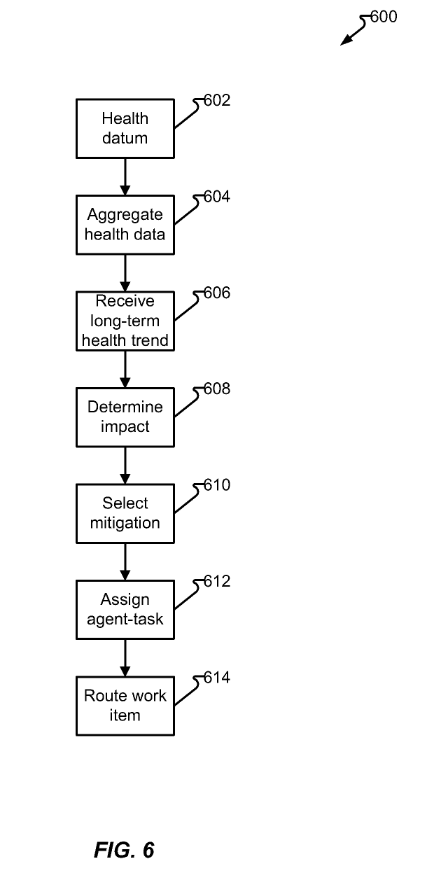

FIG. 6 depicts process 600 in accordance with embodiments of the present disclosure. In one embodiment, process 600 begins at step 602 receiving a health datum, such as an input from sensing device 104 received by server 106. Step 604 aggregates health data, such as aggregating or converting raw data (e.g., raw sensor values, individual measurements, etc.) into health data. Next, step 606 receives a long-term health trend, such as one retrieved by server 106 from data storage 108 and or determined by server 106. In one embodiment, the aggregate health data determined and/or received in step 604 may be from a historic event whereby persons, which may or may not be an agent of a contact center, may have previously affected a population determined, with at least an acceptable degree of certainty, to include one or more agents 102 of a contact center 502.

Step 608 determines the impact of a long-term health trend. Continuing the example above, a prior historical event, which caused a reduction in the cognitive performance of at least one agent 102 on a prior occurrence, may then be utilized to determine that an impact will be observed upon the recurrence of the event or at least an event that is substantially similar to the prior occurrence. Knowing the long-term health trend and its impact allows step 610 to select an appropriate mitigation strategy.

Step 610 may select a mitigation, such as to increase or decrease staff assignments of agents 102 to particular work items (e.g., 302,310) including work items having a previously determined common attribute or absence of a common attribute. An individual work item may be assigned to one agent 102 versus another, such as by assignment/routing engine 304. An agent 102 may be assigned to one particular work item or excluded from a particular work item, which also may be performed by assignment/routing engine 304. Step 612 assigns particular agents 102 work tasks such that an appropriate work item, which itself may comprise a plurality of specific work items, are matched to a particular agent 102, which may comprise an agent pool 202 or subset of agents. Step 614 then routes the appropriate work item to the appropriate agent 102 or assigns the appropriate agent 102 to a particular work item.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU), or logic circuits programmed with the instructions to perform the methods (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system comprising:
a network interface configured to receive a long-term health trend of an agent in a work pool;
a processor to determine an impact of the long-term health trend on a performance objective of the contact center and select a mitigation strategy to mitigate the long-term health trend on the performance objective;
an assignment module configured to assign a work task to a portion of the work pool in accord with the mitigation strategy; and
a switch configured to route the assigned work task to at least one agent of the portion of the work pool.

2. The system of claim 1, further comprising:
a sensor configured to receive a health indicating attribute of the agent and convert the received health indicating attribute into a long-term health trend datum; and
a data store configured to receive the long-term health trend datum for accesses by the network interface as a component of the long-term health trend.

3. The system of claim 2, wherein the processor is further configured to aggregate a plurality of long-term health trend datum into the long-term health trend.

4. The system of claim 1, wherein the long-term health trend of an agent further comprises a long-term health trend of a plurality of agents in the work pool.

5. The system of claim 1, wherein the long-term health trend of an agent further comprises a long-term health trend of a first population sample, which is determined to include the agent, with a previously determined certainty, and individuals not in the work pool.

6. The system of claim 5, wherein the long-term health trend further comprises an event affecting the first population sample.

7. The system of claim 6, wherein the event is an instance of a repeating event.

8. The system of claim 6, wherein at least one prior instance of the repeating event has affected a second population sample and the processor is further configured to determine the impact on the first population sample in accord with the impact of the at least one prior instance of the repeating event upon the second population sample.

9. The system of claim 1, wherein the mitigation strategy is associated with an alteration of the size of the portion of the work pool scheduled to perform the work task.

10. The system of claim 1, wherein the work item comprises a plurality of work items assignable to ones of the portion of the work pool.

11. The system of claim 1, wherein the long-term health trend comprises a physiological state variation from a baseline value observed over at least two work shifts of the agent.

12. A system comprising:
a sensor configured to receive a health-indicating attribute of the agent and convert the received health-indicating attribute into a long-term health trend datum;
a data store configured to receive the long-term health trend datum for access by the network interface as a component of the long-term health trend
a network interface configured to receive the long-term health trend of an agent in a work pool;
a processor to determine an impact of the long-term health trend on a performance objective of the contact center and select a mitigation strategy to mitigate the long-term health trend on the performance objective;
an assignment module configured to assign a portion of the work pool to perform a work task to in accord with the mitigation strategy; and
a switch configured to route the assigned work task to at least one agent of the portion of the work pool.

13. The system of claim 12, wherein the long-term health trend of an agent further comprises a long-term health trend of a plurality of agents in the work pool.

14. The system of claim 12, wherein the long-term health trend further comprises an event affecting the first population sample.

15. The system of claim 13, wherein the event is an instance of a repeating event and wherein at least one prior instance of the repeating event affected a second population sample and the processor is further configured to determine the impact in accord with an impact of the at least one prior instance of the repeating event upon the second population sample.

16. A method, comprising:
a network interface configured to receive a long-term health trend of an agent in a work pool;
a processor to determine an impact of the long-term health trend on a performance objective of the contact center and select a mitigation strategy to mitigate the long-term health trend on the performance objective;
an assignment module configured to assign a work task to a portion of the work pool in accord with the mitigation strategy; and
a switch configured to route the assigned work task to at least one agent of the portion of the work pool.

17. The method of claim 16, further comprising:
receiving, at a sensor, a health-indicating attribute of the agent;
converting the received health-indicating attribute into a long-term health trend datum; and
storing the long-term health trend datum in a data store configured for access by the network interface as a component of the long-term health trend.

18. The method of claim 16, wherein the health-indicating attribute of the agent further comprises a health-indicating attribute of the agent of a plurality of agents in the work pool.

19. The method of claim 16, wherein the long-term health trend of an agent further comprises a long-term health trend of a first population sample, which is determined to include the agent, with a previously determined certainty, and individuals not in the work pool

20. The method of claim 16, wherein the long-term health trend further comprises an event affecting the first population sample.
